(19) United States
(12) Patent Application Publication
(10) Pub. No.: US 2009/0158903 A1
(43) Pub. Date: Jun. 25, 2009

(54) MEAT CUTTING APPARATUS

(76) Inventor: YAN HOI YEUNG, Bayside, NY (US)

Correspondence Address: Shuang Zhang c/o Lin Guo, 136-40 39th Ave., Suite 501, Flushing, NY, 11354, US

(21) Appl. No.: 11/963,835

(22) Filed: Dec. 23, 2007

(51) Int. Cl. B26D 3/18

(52) U.S. Cl. 83/109; 83/431; 83/694; 30/355

(57) ABSTRACT

Disclosed is a meat cutting apparatus. The apparatus comprises a pusher head and a blade set, which functions like a scissor. The apparatus applies cutting and shearing force simultaneously on a meat object to make the cut much easier. In addition, a force generating system is used to gain mechanic advantage.

### FIELD OF INVENTION

This invention relates to apparatus applying cutting and shearing force simultaneously to cut meat objects. In addition, this invention relates to apparatus having a force generating means to facilitate shearing and cutting of meat objects.

### BACKGROUND OF THE INVENTION

Devices suitable for chopping and shredding vegetables, such as heads of lettuce, are described in U.S. Pat. Nos. 3,924,501, 4,346,634, and etc. In these patents, the food object was placed on a set of blades and a pusher head pushed the object directly against and through the blades. As a result, the food object was cut into shapes predefined by the blades. In these prior arts, cutting force is generated by pressing a food against blades. Same cutting principle is also applied in U.S. Pat. No. 6,558,244, which discloses an apparatus for chunking Baitfish. Due to lacking a shearing effect, the devices disclosed in these prior arts are neither suitable for nor capable of cutting meat objects, such as Chinese barbecued pork or frozen steak.

In view of the foregoing, it is apparent that there exists a need in the art for chopping apparatus which overcomes, mitigates, or solves the above problems in the art. More particularly, it is apparent that there exists a need for chopping apparatus which is capable of cutting meat objects easily.

The present invention alleviates the drawbacks associated with the prior arts. The objective of the invention is to create a chopper that can apply both shearing and cutting force on meat objects so that the objects can be easily cut into predefined shapes.

It is also an objective of the present invention that different blade sets are interchangeably assembled on the supporting frame in order to cut the meat object into different shapes. Different pusher heads are also interchangeably assembled on the pusher board to match with different blade sets.

### SUMMARY OF THE INVENTION

To solve the problems associate with the prior arts, this invention disclosed a meat chopping apparatus, comprising:

a supporting frame;

a set of blades securely attached to said supporting frame, wherein the food object is placed on said blades;

a pusher head having a number of fingers; and

one end of said pusher head being pivotally connected to one end of said supporting frame,

wherein said fingers and said blades are shaped to fit said fingers into the spaces between said blades as the angle between said pusher head and said supporting frame decreases and whereby the meat object is sheared and cut by being pushed against and through said blades until said fingers pass through the spaces between said blades.

In another preferred embodiment, a meat chopping apparatus comprising:

a supporting frame;

a set of blades securely attached to said supporting frame, wherein the food object is placed on said blades;

a pusher head having a number of fingers;

one end of said pusher head being pivotally connected to one end of said supporting frame;

a force generating means connecting to said pusher head;

wherein said fingers and said blades are shaped to fit said fingers into the spaces between said blades as the angle between said pusher head and said supporting frame decreases and whereby the meat object is sheared and cut by being pushed against and through said blades until said fingers pass through the spaces between said blades.

In both above embodiments, blades are of being serrate for further facilitating cut through meat objects.

Any other objectives, advantages, features and applicabilities of the present invention re elucidated in the following description of an illustrative embodiment of the invention in relation to the drawing. All described and/or graphically shown features whether per se or in arbitrary combination are an object the present invention, regardless of their summarization in the claims or their mutual relationships.

### BRIEF LIST OF REFERENCE NUMERALS UTILIZED IN THE DRAWING

10—First preferred embodiment of this present invention (10)
11—Handle (11)
12—Turntable-2 (12)
13—Pulling gear (13)
14—Pusher board (14)
15—Pusher Head (15)
16—Blade set (16)
17—Base assembly (17)
18—Supporting frame (18)
19—Exit (19)
21—Connecting axis (21)
22—Parallel blades (22)
23—Orthogonal blades (23)
24—Assemble covers (24)
25—Finger (25)
41—Board axis (41)
42—Frame board (42)
43—Pusher head holders (43)
51—Turntable-1 (51)
52—Turntable-1 axis (52)
53—Turntable-2 axis (53)
54—Connector (54)

### BRIEF DESCRIPTION OF THE DRAWINGS

A more thorough understanding of the present invention may be obtained by a study of the following detailed description taken in connection with the accompanying drawings in which:

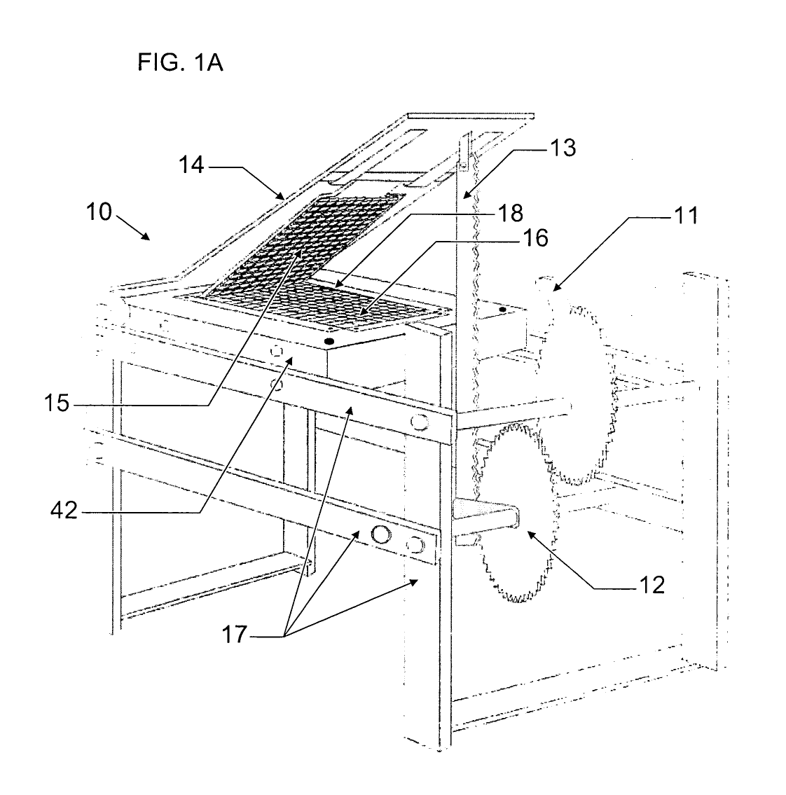

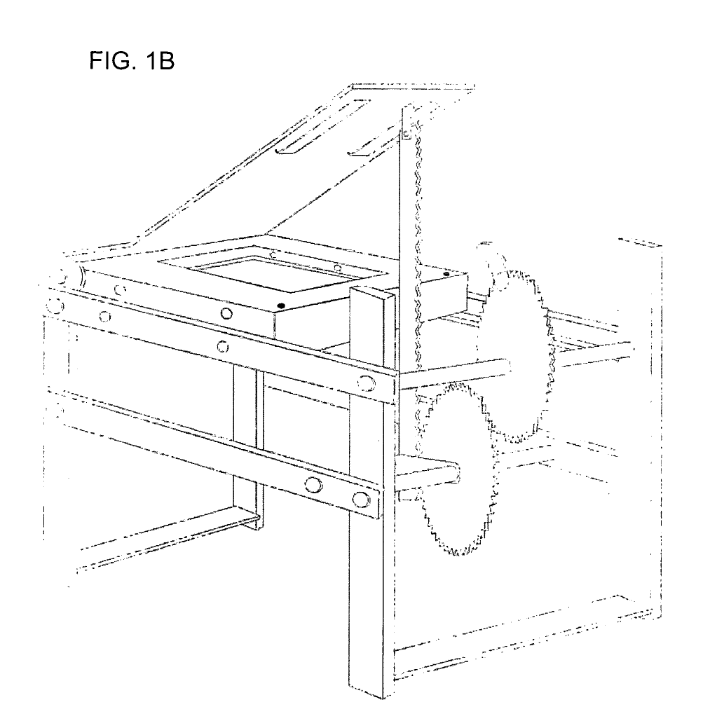

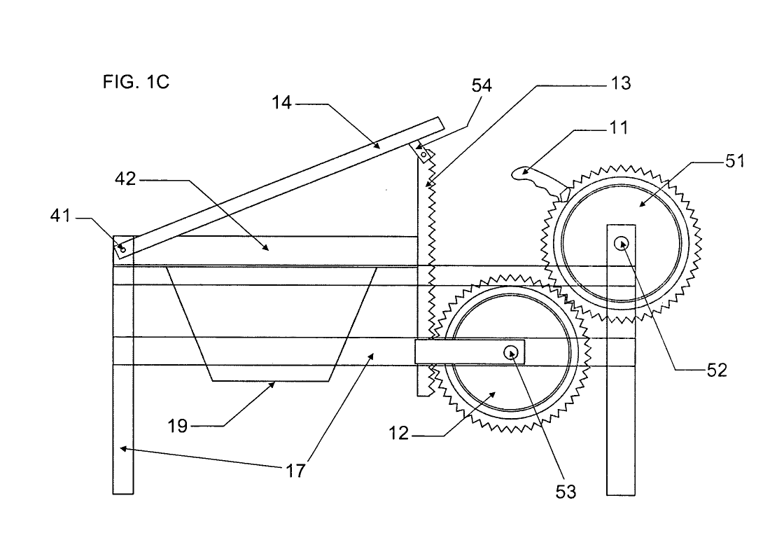

FIG. 1A is a perspective view of an embodiment of the present invention in the opened position.

FIG. 1B is a perspective view of the embodiment of FIG. 1A with pusher head and blade set removed.

FIG. 1C is a side view of the embodiment of FIG. 1A.

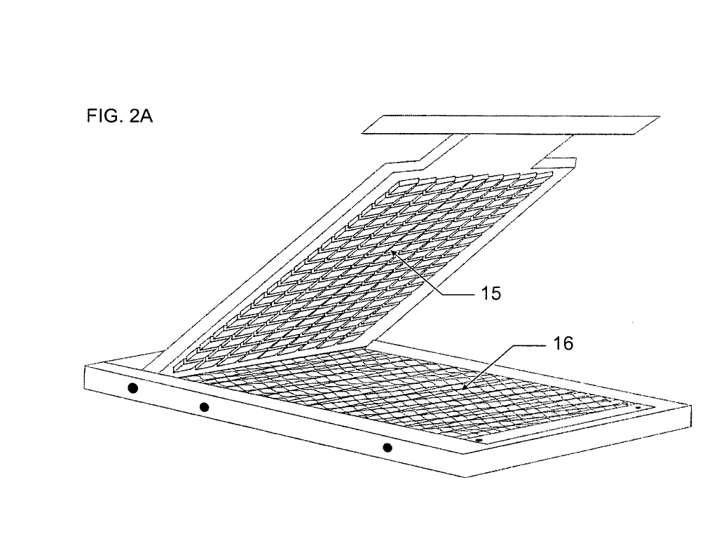

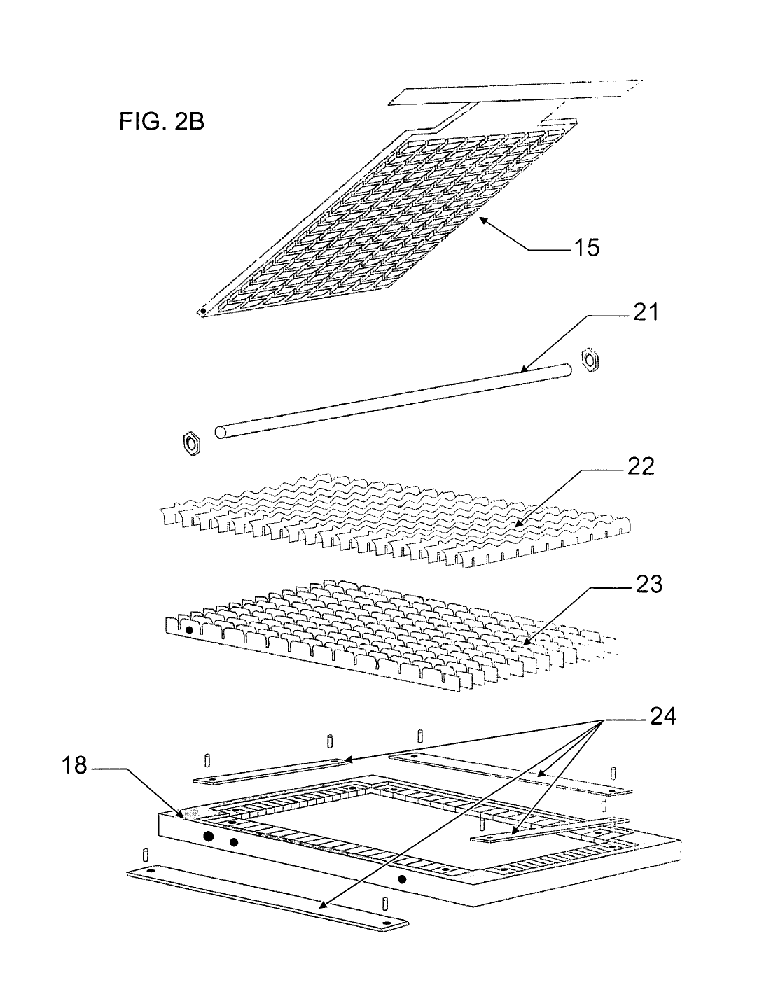

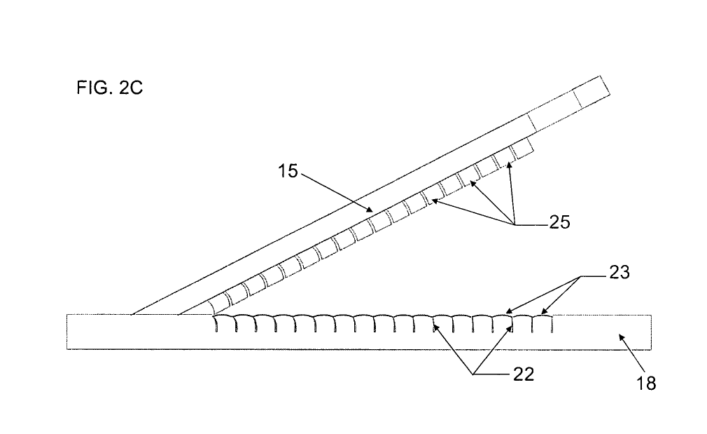

FIG. 2A is a perspective view of pusher head and blade set of the embodiment of FIG. 1A.

FIG. 2B is an exploded view of pusher head and blade set of FIG. 2A.

FIG. 2C is a side view of pusher head and blade set of FIG. 2A.

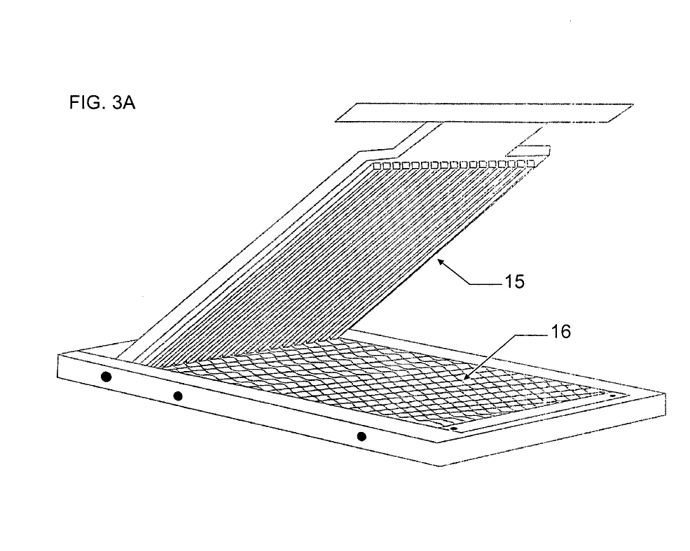

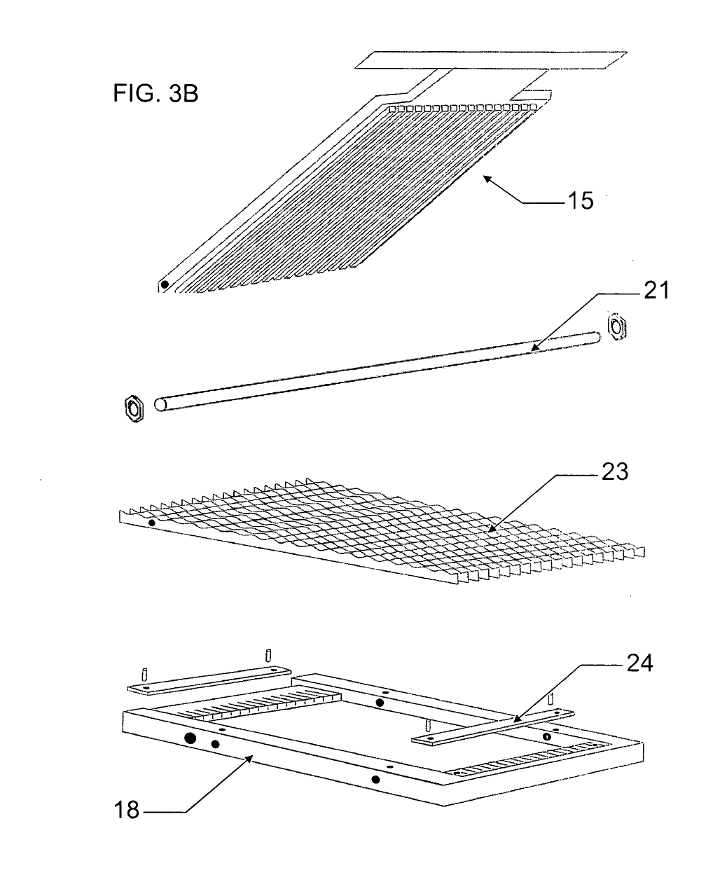

FIG. 3A is a perspective view of pusher head and blade set of another embodiment.

FIG. 3B is an exploded view of pusher head and blade set of FIG. 3A.

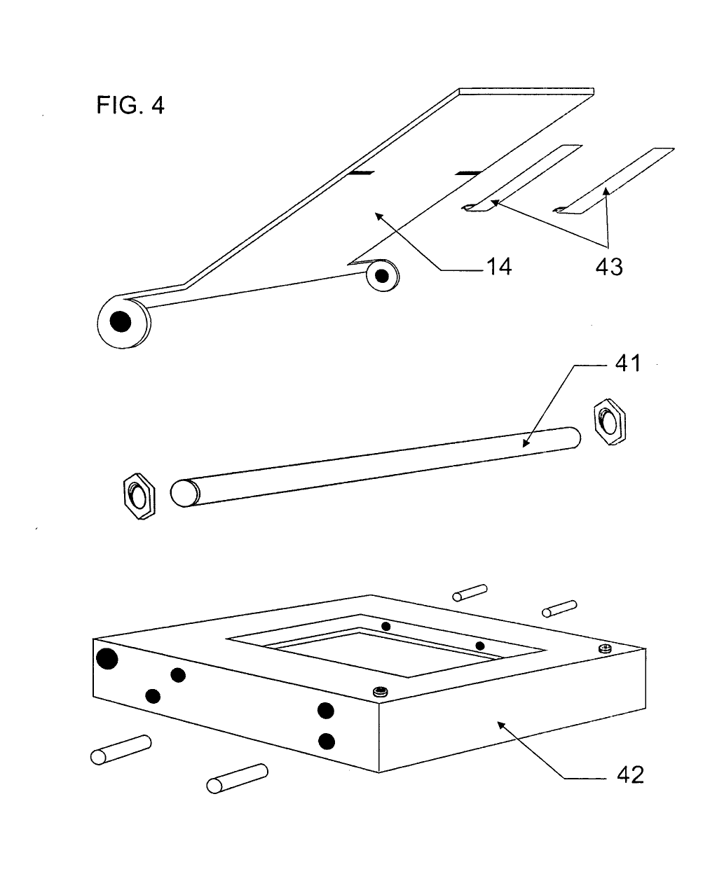

FIG. 4 is an exploded view of pusher board and frame board.

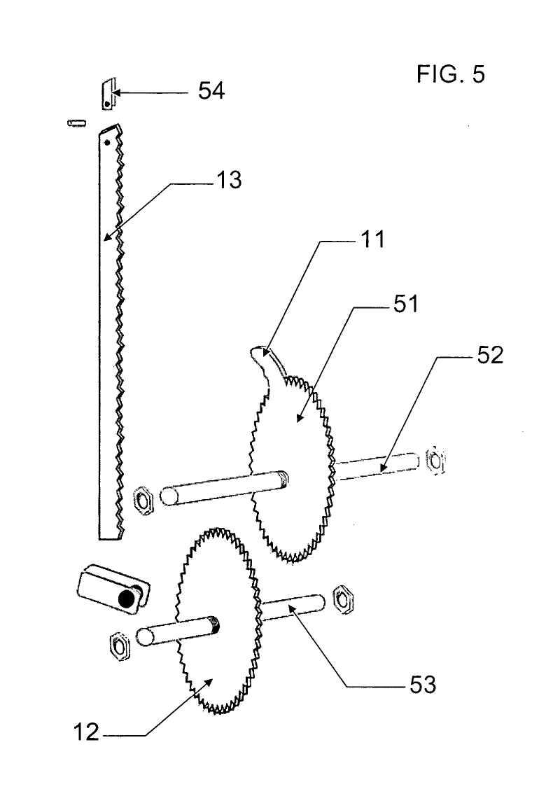

FIG. 5 is an exploded view of force generating assembly of the embodiment of FIG. 1A.

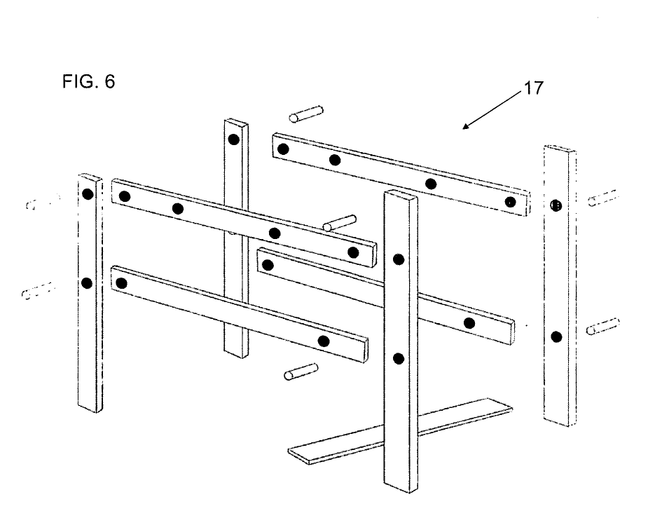

FIG. 6 is an exploded view of base assembly of the embodiment of FIG. 1A.

### DESCRIPTION OF THE PREFERRED EMBODIMENTS

Referring now to FIG. 1A and FIG. 1C, the present invention is shown in a first preferred embodiment. The meat cutting apparatus 10 comprises a cutting board, a force generating system, and a base assembly 17 that holds the cutting board and the force generating system together. The cutting board comprises a blade set 16 attached to a supporting frame 18 that is installed on a frame board 42, and a pusher head 15 that is installed on a pusher board 14. The force generating system comprises a handle 11, a set of turntables, and a pulling gear 13. The force generating system is securely connected to the open end of the cutting board through a connector 54. By operating the handle 11, one can control the angle between the pusher board 14 and the frame board 42, which in turn alters the angle between the pusher head 15 and the blade set 16. The blade set 16 with the supporting frame 18 and the pusher head 15 are removable so different blade set and pusher head can be installed. FIG. 1B shows the meat cutting apparatus with the pusher head 15 and the blade set 16 with the supporting frame 18 removed. Sheared and chopped meat pieces fall through the exit 19, where a serving plate is placed.

Referring to FIG. 2A, it is a perspective view of the pusher head 15 and the blade set 16 of the meat cutting apparatus 10 in FIG. 1A. Its detail structure is shown in FIG. 2B. To cut meat objects into pieces, the blade set 16 consists of two groups of blades 22/23 that are installed on the supporting frame 18 at the directions perpendicular to each other. The installation is secured with assemble covers 24. The supporting frame 18 and the pusher head 15 are connected by a connecting axis 21. For further facilitating cut through meat objects, both blade sets 22/23 are of being serrate.

FIG. 2C is the side-view of FIG. 2A, showing the shapes of the fingers 25 on the pusher head 15 and the blades 22 on the supporting frame 18. To smoothly fit the fingers 25 into the spaces between the blades 22 as the angle between the pusher head 15 and the supporting frame 18 decreases, the fingers 25 and the blades 22 are constructed into certain arch shape. The curvature of the arch shape varies at different blade position. FIG. 2C also shows that the meat cutting apparatus functions like a scissor to cut a meat object from one end to the other end. Therefore, the apparatus applies cutting and shearing force simultaneously on a meat object to make the cut much easier.

Referring to FIG. 3A, another set of pusher head and blade set is shown. This set is used to cut a meat object into strips. FIG. 3B shows its detail structure of the pusher head and the blade set in FIG. 3A.

Referring to FIG. 4, the detail structure of the pusher board 14 and the frame board 42 is shown. The pusher board 14 and the frame board 42 are connected by a board axis 41. A pair of pusher head holders 43, where a pusher head is installed, is attached to the pusher board 14.

Referring to FIG. 5, it shows the detail structure of the force generating system of the meat cutting apparatus 10 in FIG. 1A. Rotation of the turntable-1 51 by handle 11 will rotate the turntable-2 axis 53, which in turn pushes the pulling gear 13 forward or backward. Through the connector 54, which links the force generating system to the pusher board, the angle between the pusher board 14 and the frame board 42 changes.

Referring to FIG. 6, it shows the detail structure of the base assembly 17 of the meat cutting apparatus 10 in FIG. 1A.

In the preferred embodiment, the force generating system is operated manually. However, it is conceivable that a motor can be used to drive the meat cutting apparatus.

In the preferred embodiment, the base assembly 17 is constructed in a way detailed in FIG. 6. However, it is conceivable that such construction can be arranged differently.

Therefore, we declare that although an exemplary embodiment of the invention has been disclosed herein for purposes of illustration, it should be understood that various changes, modifications and substitutions might be incorporated in such embodiment without departing from the spirit of the invention as defined by the claims which follow.

What is claimed is:

1. A meat object cutting apparatus comprising:
a supporting frame;
a set of blades securely attached to said supporting frame, wherein the meat object is placed on said blades; and
a pusher head having a number of fingers, one end of said pusher head being pivotally connected to one end of said supporting frame,
wherein said fingers and said blades are shaped to fit said fingers into the spaces between said blades as the angle between said pusher head and said supporting frame decreases and whereby the meat object is sheared and cut by being pushed against and through said blades until said fingers pass through the spaces between said blades.

2. The meat object cutting apparatus according to claim 1, further comprising a force generating means connecting to said pusher head to facilitate close of the angle between said pusher head and said supporting frame.

3. The meat object cutting apparatus according to claim 2, wherein said blades comprising at least one blade orthogonal to the pivotal connection between said pusher head and said supporting frame.

4. The meat object cutting apparatus according to claim 2, wherein said blades further comprising at least one blade parallel to the pivotal connection between said pusher head and said supporting frame.

5. The meat object cutting apparatus according to claim 1, wherein said blades are of being serrate.

6. A meat object cutting apparatus comprising:
a supporting frame;
a set of blades securely attached to said supporting frame, wherein the food object is placed on said blades;
a pusher head having a number of fingers, wherein one end of said pusher head being pivotally connected to one end of said supporting frame; and
a force generating means connecting to said pusher head,
wherein said fingers and said blades are shaped to fit said fingers into the spaces between said blades as the angle between said pusher head and said supporting frame decreases and whereby the meat object is sheared and cut by being pushed against and through said blades until said fingers pass through the spaces between said blades.

7. The meat object cutting apparatus according to claim 6, wherein said blades are of being serrate.

8. A meat object cutting apparatus comprising:
a supporting frame;
a set of blades securely attached to said supporting frame, wherein the food object is placed on said blades;
a pusher head having a number of fingers, wherein one end of said pusher head being pivotally connected to one end of said supporting frame; and
a force generating means connecting to said pusher head,
wherein said blades are in arc shape to fit said fingers into the spaces between said blades as the angle between said pusher head and said supporting frame decreases and whereby the meat object is sheared and cut by being pushed against and through said blades until said fingers pass through the spaces between said blades.

9. The meat object cutting apparatus according to claim 8, wherein said blades are of being serrate.
